(19) United States
(12) Patent Application Publication
(10) Pub. No.: US 2011/0249017 A1
(43) Pub. Date: Oct. 13, 2011

(54) Image signal processing device, display device, display method and program product

(75) Inventors: Nobutane Chiba, Kanagawa (JP); Yasuyuki Uemura, Kanagawa (JP)

(73) Assignee: Sony Corporation, Tokyo (JP)

(21) Appl. No.: 13/065,758

(22) Filed: Mar. 29, 2011

(30) Foreign Application Priority Data
Apr. 7, 2010 (JP) P2010-088958

(51) Int. Cl. G09G 5/02

(52) U.S. Cl. 345/589

(57) ABSTRACT

An image processing device includes an input unit that receives at least one of image signals for a left channel and image signals for a right channel, a color conversion processing unit that converts at least one of the image signals for the left channel and the image signals for the right channel, which are input to the input unit, into image signals for a solid color image of a specific color, and an output unit that outputs image signals including the image signals converted in the color conversion processing unit.

### CROSS-REFERENCE TO RELATED APPLICATION

The present application claims priority from Japanese Patent Application No. JP 2010-088958 filed in the Japanese Patent Office on Apr. 7, 2010, the entire content of which is incorporated herein by reference.

### BACKGROUND OF THE INVENTION

1. Field of the Invention

The present invention relates to an image signal processing device which processes image signals for a stereoscopic display, a display device which displays images based on the processed image signals, a display method which is applied to a display process in the display device, and a program product which executes the display method.

2. Description of the Related Art

In the related art, in a case where image signals for a stereoscopic display (3D display) are supplied to and displayed on a display device such as a monitor display, image signals for a left channel and image signals for a right channel are supplied to the display device. Images based on the image signals for the respective channels are separately viewed by the left and right eyes of a person viewing the display device.

For example, the person viewing the display device wears a glasses-type liquid crystal shutter device in which shutters for the right eye and the left eye are alternately opened and closed for each frame. Further, an image for the left channel and an image for the right channel are alternately displayed on the display device for each frame, and the shutters for the left and right eyes are alternately opened and closed for each frame, thereby recognizing the images based on the image signals for the respective channels with the left and right eyes. On the other hand, there is a type of implementing stereoscopic vision by the process in a display device without wearing special glasses or the like. As display methods, there are various methods, in addition to the above-described method of changing images for the left channel and images for the right channel for each frame, for example, a method of changing images for the left and right channels for each horizontal line or the like.

In this way, the displayed images can be implemented for stereoscopic vision.

Japanese Unexamined Patent Application Publication No. 2004-104329 discloses a variety of processes for implementing a stereoscopic vision using images for left and right channels.

### BRIEF SUMMARY OF THE INVENTION

When images for implementing such a stereoscopic vision are captured, it is important to display and confirm the images on a display device for capturing or editing the images.

In other words, image signals for implementing the stereoscopic vision are obtained as image signals for a left channel and image signals for a right channel by capturing images of the same subject using two video cameras which are typically arranged with a predetermined gap in the horizontal direction. Therefore, the image for the left channel and the image for the right channel are almost the same, and thus the left and right images are hardly differentiated at a glance. Further, it is not easy to know to what extent stereoscopic display is implemented, from a typical display device, not for use with the stereoscopic display.

FIGS. 10A and 10B show the relationship between an actual situation for capturing and the captured image. As shown in FIG. 10A, from the upper side thereof, there are a subject a in front of a reference plane c, and buildings b1 to b9 which are arranged from the rear side of the reference plane c to the front side of the reference plane c in a sequentially varying state. If an image of this state is captured with a camera device 1, the captured image includes the subject a and the buildings b1 to b9 which are arranged as shown in FIG. 10B. Here, the buildings b1 to b9 are different from the reference plane c in the positional relationship, and, for example, when capturing for a stereoscopic vision is performed, the positions of the left channel image and the right channel image vary; however, when each of the channel images is seen separately as shown in FIGS. 10A and 10B, the positions hardly vary. Therefore, there is a problem in that if each of the channel images is separately displayed on a typical display device, not for use for stereoscopic display, it is difficult to determine the implementation of stereoscopic vision effects.

In order to implement the stereoscopic vision through the display of images based on the image signals, it is necessary for the image signals for the left and right channels to be exactly synchronized with each other, and it is important for displayed positions of the left and right images not to be misaligned. However, even such confirmation is difficult to perform from a typical display device not for use for stereoscopic display.

It is desirable to use a typical display device and to satisfactorily confirm images or the like used to implement stereoscopic vision.

According to an embodiment of the present invention, there is a provided a color conversion unit. The color conversion processing unit converts at least one of image signals for a left channel and image signals for a right channel into image signals for a solid color image of a specific color.

In this way, image portions for one channel displayed in the solid color of the specific color are displayed with image portions for the other channel in an overlapping manner, and thus places where the image portions for the left and right channels vary can be ascertained from a situation where the specific color portions are displayed. Further, whether or not the display timing, display position or the like of the images for the left and right channels is synchronized can be easily ascertained.

According to the present invention, it is possible to simply confirm images for implementing stereoscopic display through the confirmation of a display state concerning a situation of color portions which have undergone a color conversion process.

### BRIEF DESCRIPTION OF THE DRAWINGS

FIG. 1 is a block diagram illustrating a configuration example of a system according to an embodiment of the present invention.

FIG. 2 is a block diagram illustrating a configuration example of an image processing device according to an embodiment of the present invention.

FIG. 3 is a diagram illustrating a process example for each display mode according to an embodiment of the present invention.

FIGS. 4A and 4B are diagrams illustrating a process example in a left channel emphasis mode according to an embodiment of the present invention.

FIGS. 5A and 5B are diagrams illustrating a process example in a right channel emphasis mode according to an embodiment of the present invention.

FIGS. 6A and 6B are diagrams illustrating a process example in a left and right channel emphasis mode according to an embodiment of the present invention.

FIG. 7 is a diagram illustrating a scale display example according to an embodiment of the present invention.

FIG. 8 is a block diagram illustrating a configuration example of a system according to another embodiment of the present invention.

FIG. 9 is a block diagram illustrating a configuration example of a system according to still another embodiment of the present invention.

FIGS. 10A and 10B are diagrams illustrating a display example of an image.

### DETAILED DESCRIPTION

Embodiments of the present invention will be described in the following order.

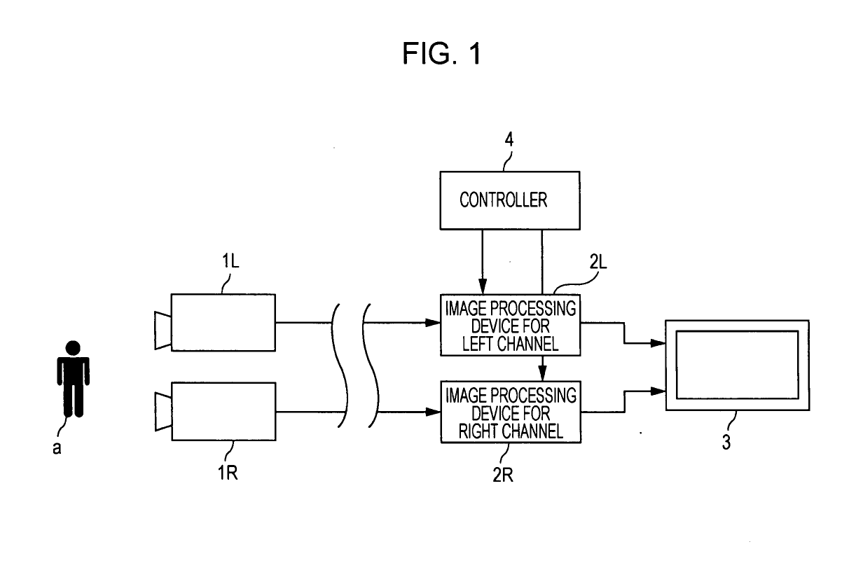

A configuration example of a system according to an embodiment (FIG. 1);

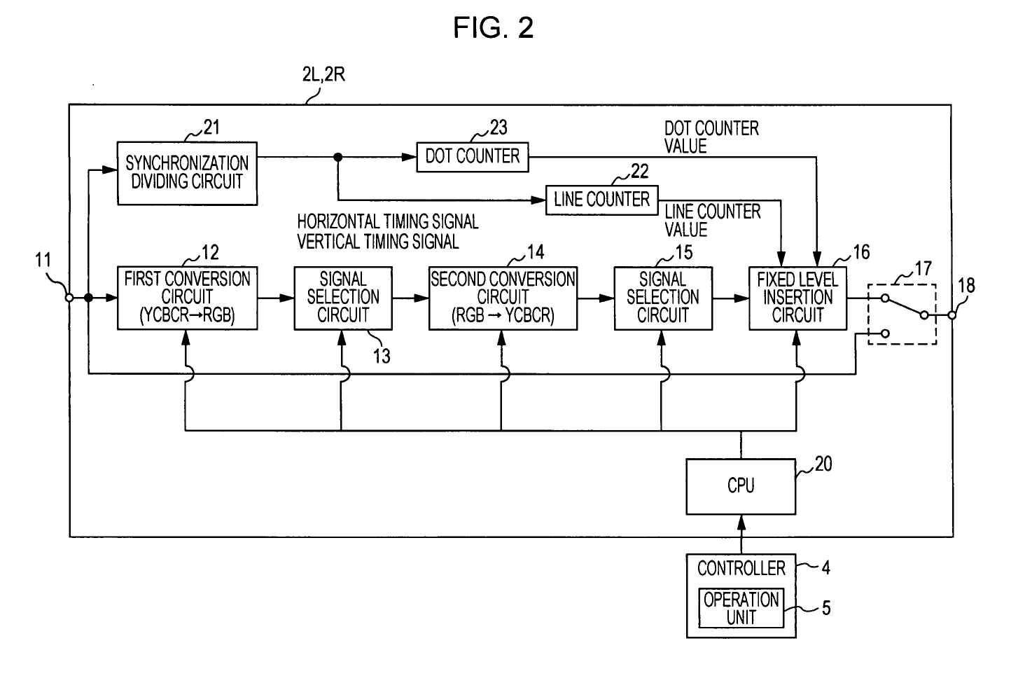

A configuration example of an image processing device according to an embodiment (FIG. 2);

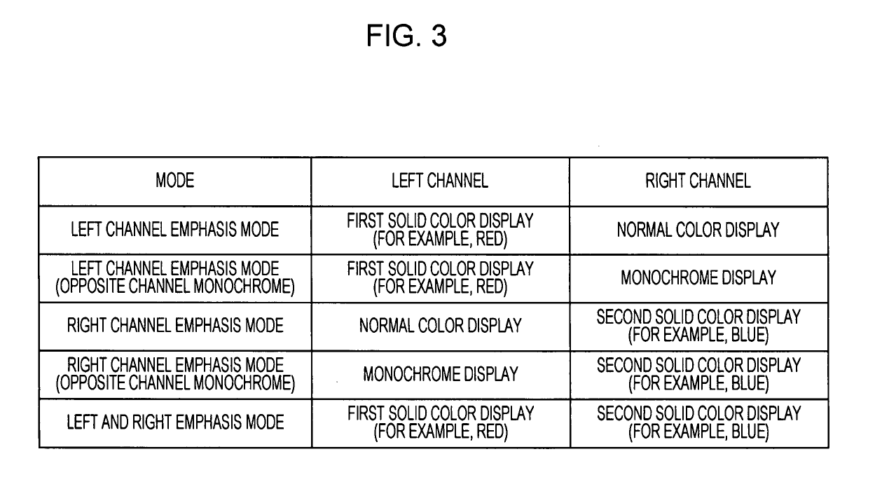

Description of a process in each display mode (FIGS. 3 to 7);

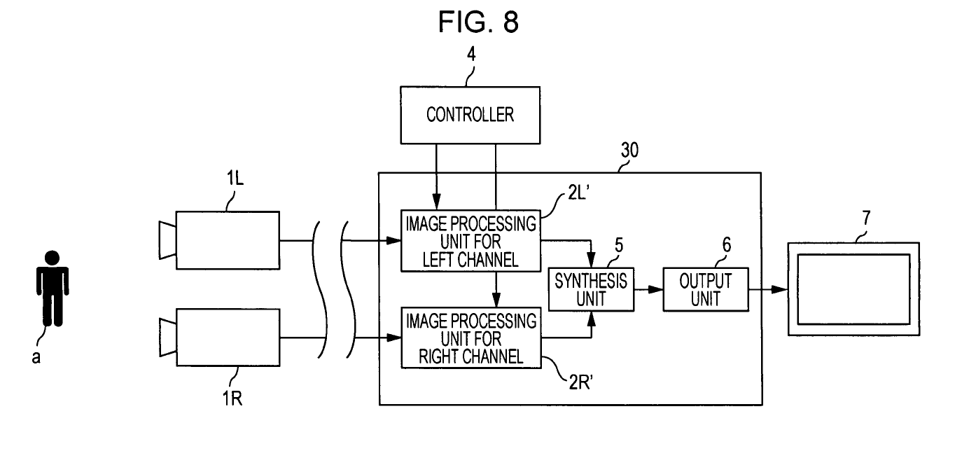

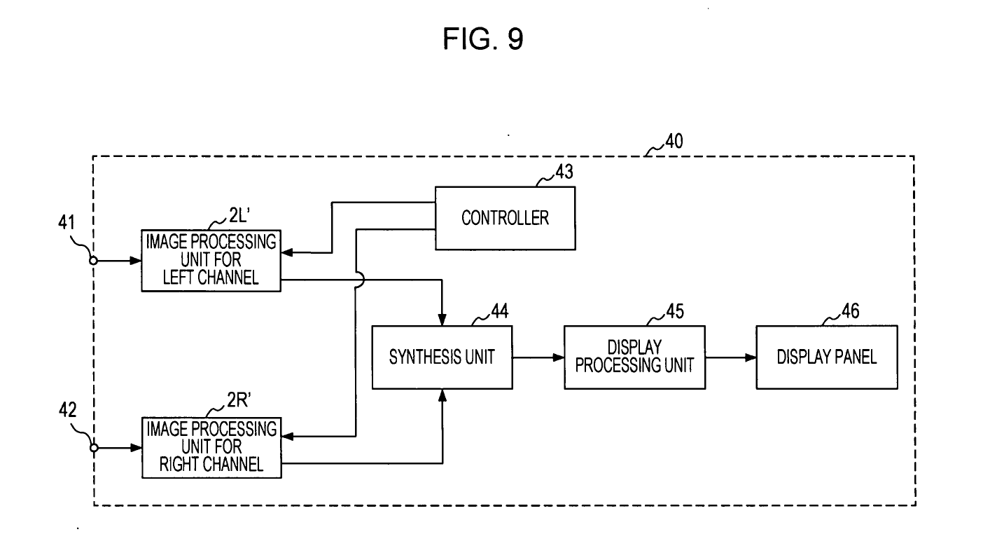

A configuration example of a system according to another embodiment (FIGS. 8 and 9);

A configuration example of a system according to an embodiment.

Hereinafter, a configuration example of a system according to this embodiment will be described with reference to FIG. 1.

The system in this embodiment is supplied with image signals for a left channel and image signals for a right channel which are image signals used to implement stereoscopic vision and processes the image signals. That is to say, images of a subject a are captured with a camera device 1L for a left channel and a camera device 1R for a right channel, and image signals for the left channel and image signals for the right channel are output as image signals for a 3D display.

The image signals for the left channel output from the camera device 1L for the left channel is supplied to an image processing device 2L for the left channel. The image signals for the right channel output from the camera device 1R for the right channel is supplied to an image processing device 2R for the right channel. The image processing device 2L for the left channel and the image processing device 2R for the right channel process the supplied image signals in response to an instruction from a controller 4. The controller 4 is a control unit which performs an instruction for display modes based on a user's operation. Detailed examples of the display modes will be described later.

The image processing device 2L for the left channel and the image processing device 2R for the right channel are configured independently in FIG. 1, but may be integrated into one device. Further, controller 4 may be integrally formed with the image processing devices.

The image processing device 2L for the left channel and the image processing device 2R for the right channel process the input image signals in response to an instruction from the controller 4, and outputs the processed image signals. In some cases, the image processing device 2L for the left channel and the image processing device 2R for the right channel do not perform any process and outputs the image signals as they are, in response to an instruction from the controller 4. Detailed configuration examples of the respective image processing devices 2L and 2R will be described later.

The image signals output from the image processing device 2L for the left channel and the image processing device 2R for the right channel are supplied to a display device 3, and the display device 3 displays images based on the input image signals.

The display device 3 is a 3D display device which can implement stereoscopic vision. In other words, the display device 3 performs a display process for the input image signals for the left channel and the input image signals for the right channel at the same time, and alternately displays the images for the two channels on a single screen for each frame or for each line.

### A Configuration Example of the Image Processing Device According to an Embodiment

Configurations examples of the image processing device 2L for the left channel and the image processing device 2R for the right channel are described with reference to FIG. 2.

The image processing device 2L for the left channel fundamentally has the same configuration as the image processing device 2R for the right channel, and FIG. 2 shows only one configuration of the image processing devices.

Referring to FIG. 2, image signals input to an input terminal 11 is supplied to a first conversion circuit 12. The first conversion circuit 12 converts the image signals Y, CB and CR including a luminance signal and a color difference signal into image signals R, G and B including primary color signals. The first conversion circuit 12 performs a conversion according to the following Equation 1 using a matrix circuit.

$$( \begin{matrix}R \\ G \\ B\end{matrix} ) = ( \begin{matrix}A 1 & A 2 & A 3 \\ B 1 & B 2 & B 3 \\ C 1 & C 2 & C 3\end{matrix} ) ( \begin{matrix}Y \\ CB \\ CR\end{matrix} ) \qquad Equation 1$$

The image signals R, G and B converted in the first conversion circuit 12 are supplied to a signal selection circuit 13. The signal selection circuit 13 extracts only a color to be emphasized from the image signals R, G and B. The signal selection circuit 13 performs an emphasis process through a conversion according to the following Equation 2 using the matrix circuit.

$$( \begin{matrix}r \\ g \\ b\end{matrix} ) = ( \begin{matrix}α 1 & α 2 & α 3 \\ β 1 & β 2 & β 3 \\ γ 1 & γ 2 & γ 3\end{matrix} ) ( \begin{matrix}R \\ G \\ B\end{matrix} ) \qquad Equation 2$$

The image signals which have undergone the selection process in the signal selection circuit 13 are supplied to a second conversion circuit 14. The second conversion circuit 14 reconverts the image signals R, G and B including the primary color signals into the image signals Y, CB and CR including the luminance signal and the color difference signal. The second conversion circuit 14 performs a conversion according to the following Equation 3 using the matrix circuit.

$$( \begin{matrix}{Y}^{′} \\ {CB}^{′} \\ {CR}^{′}\end{matrix} ) = ( \begin{matrix}X 1 & X 2 & X 3 \\ Y 1 & Y 2 & Y 3 \\ Z 1 & Z 2 & Z 3\end{matrix} ) ( \begin{matrix}r \\ g \\ b\end{matrix} ) \qquad Equation 3$$

The image signals Y, CB and CR converted in the second conversion circuit 14 are supplied to a signal selection circuit 15. The signal selection circuit 15 performs a color conversion for the image signals Y, CB and CR in response to an instruction. The signal selection circuit 15 selectively performs a conversion process into a monochrome signal (black and white signal) or a conversion process into a solid color image signal of a specific color. The signal selection circuit 15 performs a conversion according to the following Equation 4 using the matrix circuit.

$$( \begin{matrix}{Y}^{″} \\ {CB}^{″} \\ {CR}^{″}\end{matrix} ) = ( \begin{matrix}L 1 & L 2 & L 3 \\ M 1 & M 2 & M 3 \\ N 1 & N 2 & N 3\end{matrix} ) ( \begin{matrix}{Y}^{′} \\ {CB}^{′} \\ {CR}^{′}\end{matrix} ) \qquad Equation 4$$

Examples of the conversion process into a solid color image signal of a specific color in the signal selection circuit 15 include a conversion process into an image signal having only a red color component, a conversion process into an image signal having only a green color component, and a conversion process into an image signal having only a blue color component, in a case where primary color signal based colors are treated. Further, in a case where complementary color signal based colors are treated, examples thereof include a conversion process into an image signal having only a yellow color component, a conversion process into an image signal having only a cyan color component, and a conversion process into an image signal having only a magenta color component.

The image signals having undergone the selection process in the signal selection circuit 15 are supplied to a fixed level insertion circuit 16. The fixed level insertion circuit 16 selectively inserts a fixed level of images (characters, figures, or the like) into an instructed position inside an image regarding each frame. Examples of the inserted image include the character “L” indicating the left channel, the character “R” indicating the right channel, a scale (memory) figure indicating a stereoscopic situation, and the like.

A position where the image is inserted by the fixed level insertion circuit 16 is set based on a horizontal timing signal and a vertical timing signal which are divided from the input image signals by a synchronization dividing circuit 21. That is to say, the vertical timing signal obtained by the synchronization dividing circuit 21 is supplied to a line counter 22 so as to output a line counter value indicating a position of a horizontal line, and the line counter value is supplied to the fixed level insertion circuit 16. Further, the horizontal timing signal obtained by the synchronization dividing circuit 21 is supplied to a dot counter 23 so as to output a dot counter value indicating a pixel position (a dot position) which belongs to a horizontal line, and the dot counter value is supplied to the fixed level insertion circuit 16. The fixed level insertion circuit 16 determines a position of the image being inserted from these counter values.

The image signals having undergone the process in the fixed level insertion circuit 16 are supplied to a switch 17. The switch 17 selects either of the image signals output from the fixed level insertion circuit 16 and the image signals input to the input terminal 11, and outputs the selected image signals via an output terminal 18.

The image processing devices 2L and 2R have configurations where the processes in the respective circuits 12 to 16 or the switch 17 are controlled by a CPU 20 which is a control unit, and controls corresponding to display modes instructed from an external controller 4 are performed. The controller 4 includes an operation unit 5 used for a user to set display modes or the like, and instructs the CPU 20 depending on the modes or the like input via the operation unit 5.

Description of a Process for each Display Mode

Next, display modes in which the image processing devices 2L and 2R perform the process will be described.

FIG. 3 shows a list of exemplary modes in this embodiment and processes for the left channel image signals and the right channel image signals for each mode.

As prepared display modes, there are a left channel emphasis mode, a right channel emphasis mode, and a left and right channel emphasis mode. In the left channel emphasis mode and the right channel emphasis mode, a mode where an image for an opposite channel is displayed in monochrome is also prepared.

In the case of the left channel emphasis mode, first solid color image signals are output as the left channel image signals, and the initially input color image signals are output as the right channel image signals. The first solid color is, for example, the color red.

In the left channel emphasis mode, if an image for the opposite channel is displayed in monochrome, the first solid color image signals are output as the left channel image signals, and monochrome image signals are output as the right channel image signals.

In the case of the right channel emphasis mode, second solid color image signals are output as the right channel image signals, and the initially input color image signals are output as the left channel image signals. The second solid color is, for example, the color blue.

In the right channel emphasis mode, if an image for the opposite channel is displayed in monochrome, the second solid color image signals are output as the right channel image signals, and monochrome image signals are output as the left channel image signals.

In the case of the left and right emphasis mode, the first solid color image signals are output as the left channel image signals, and the second solid color image signals are output as the right channel image signals.

Further, a color set in each mode can be freely changed through a user's operation.

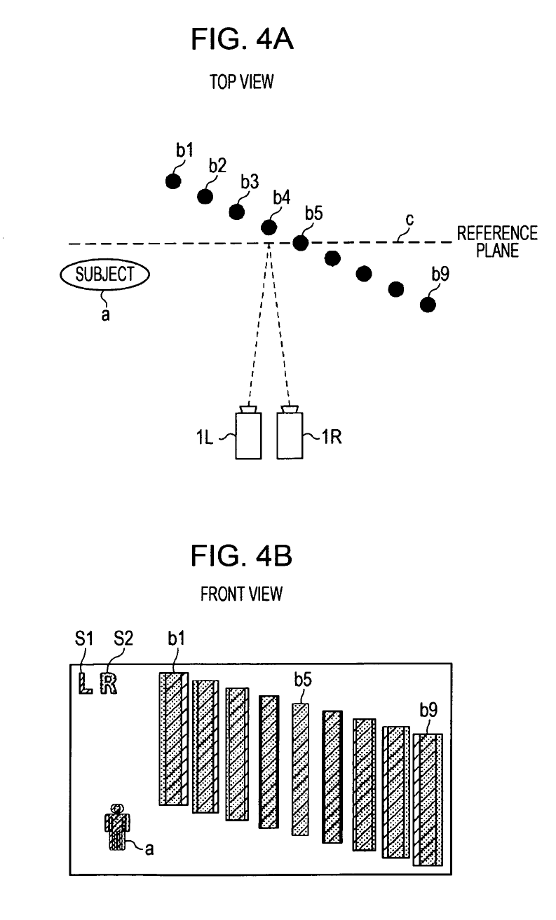

Next, examples in a case where images based on the image signals having undergone the mode setting in the image processing device 2L for the left channel and the image processing device 2R for the right channel are displayed on the display device 3 are shown in FIGS. 4A to 7.

FIGS. 4A and 4B show a capture state and a display example in the left channel emphasis mode.

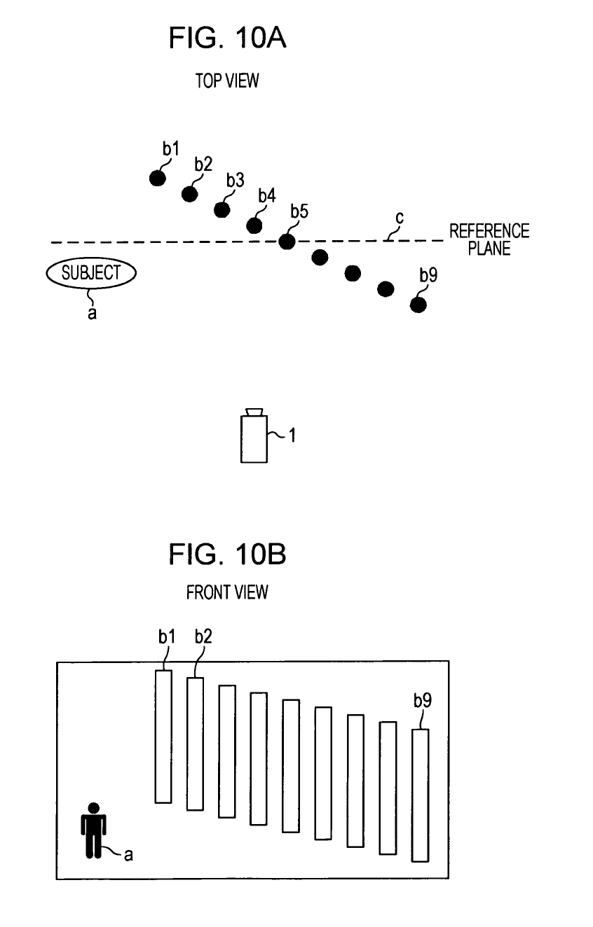

As shown in FIG. 4A, from the upper side thereof, there are a subject a in front of a reference plane c, and buildings b1 to b9 which are arranged from the rear side of the reference plane c to the front side of the reference plane c in a sequentially varying state. It is assumed that an image of this state is captured with the camera devices 1L and 1R for the left and right channels. The captured image is shown in FIG. 10B.

Also, image signals for the respective channels obtained by the capturing are processed by the image processing device 2L for the left channel and the image processing device 2R for the right channel, and the left and right channel images are displayed simultaneously (or alternately) on the display device 3. FIG. 4B shows an image displayed in this way.

As shown in FIG. 4B, in the left channel emphasis mode, only the image portions based on the image signals for the left channel captured by the camera device 1L for the left channel are painted the solid color, and the solid color portions are marked with the diagonal lines. In addition, the image portions, that is, the buildings b1 to b9 or the subject a, based on the image signals for the right channel captured by the camera device 1R for the right channel are marked with dots with a predetermined interval for differentiation from the image portions for the left channel.

Since the respective buildings b1 to b9 are positioned differently with respect to the reference plane c, states where the ranges of the image portions for one channel marked with the diagonal lines overlap with the ranges of the image portions for the other channel marked with a general color (an initial color represented by the image signals) sequentially vary. That is to say, in the innermost building b1, the image portion for the left channel overlaps with the image portion for the right channel in a state of being deviated rightwards, and in the building b5 located in the same position as the reference plane c, the image portions for the left and right channels correspond with each other. In the hithermost building b9, the image portion for the left channel overlaps with the image portion for the right channel in a state of being deviated leftwards.

Also, in this example, the “L” mark S1 and the “R” mark S2 which are characters indicating the left and right channels are displayed on the corner of the screen, and, of the two marks, the color of the “L” mark S1 indicating the left channel is a solid color. The color thereof is the same as the color of the entire image portions for the left channel. The “R” mark S2 indicating the right channel is displayed in white or in black.

Moreover, in the left channel emphasis mode, in a case where an image for the opposite channel is displayed in monochrome mode, the image portions for the right channel are displayed in monochrome, and the image portions for the left channel are displayed in the set solid color (a color other than the black) in the image shown in FIG. 4B.

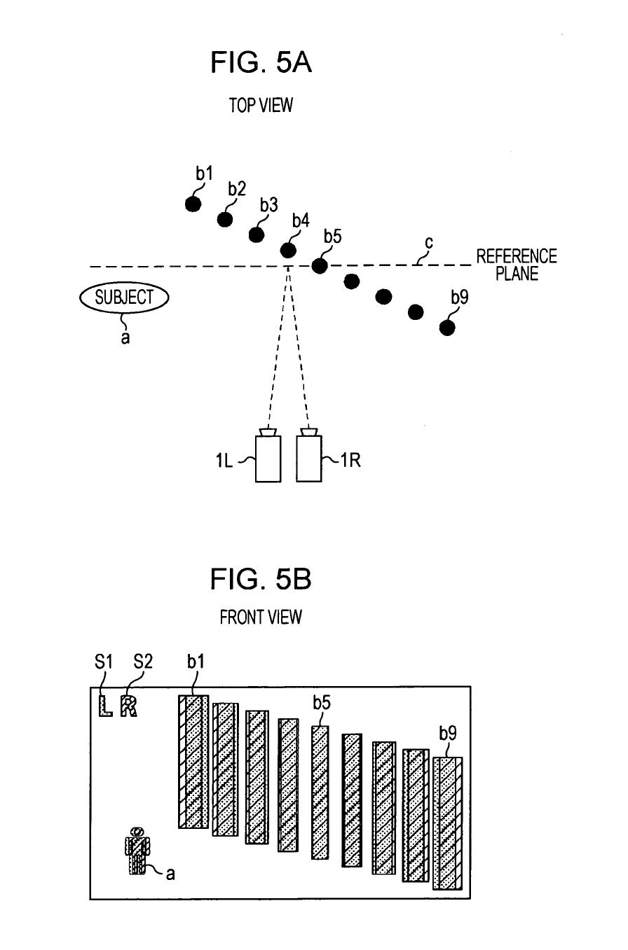

FIGS. 5A and 5B show a capture state and a display example in the right channel emphasis mode.

FIG. 5A is a diagram illustrating a capture state when seen from the top and shows the same capture state as in FIG. 4A. Also, image signals for the respective channels obtained by the capturing are processed by the image processing device 2L for the left channel and the image processing device 2R for the right channel, and the left and right channel images are displayed simultaneously (or alternately) on the display device 3. FIG. 5B shows an image displayed in this way.

As shown in FIG. 5B, in the right channel emphasis mode, only the image portions based on the image signals for the right channel captured by the camera device 1R for the right channel are plotted in the solid color, and the solid color portions are marked with the diagonal lines. In addition, the image portions, that is, the buildings b1 to b9 or the subject a, based on the image signals for the left channel captured by the camera device 1L for the left channel are marked with dots with a predetermined interval for differentiation from the image portions for the right channel.

Since the respective buildings b1 to b9 are positioned differently with respect to the reference plane c, states where the ranges of the image portions for one channel marked with the diagonal lines overlap with the ranges of the image portions for the other channel marked with a general color (an initial color represented by the image signals) sequentially vary. That is to say, in the innermost building b1, the image portion for the right channel overlaps with the image portion for the left channel in a state of being deviated leftwards, and in the building b5 located in the same position as the reference plane c, the image portions for the left and right channels correspond with each other. In the hithermost building b9, the image portion for the right channel overlaps with the image portion for the left channel in a state of being deviated rightwards.

Also, in this example, the “L” mark S1 and the “R” mark S2 which are characters indicating the left and right channels are displayed on the corner of the screen, and, of the two marks, the color of the “R” mark S2 indicating the right channel is a solid color. The color thereof is the same as the color of the entire image portions for the right channel. The “L” mark S1 indicating the left channel is displayed in white or in black.

Moreover, in the right channel emphasis mode, in a case where an image for the opposite channel is displayed in the monochrome mode, the image portions for the left channel are displayed in monochrome, and the image portions for the right channel are displayed in the set solid color (a color other than the black) in the display shown in FIG. 5B.

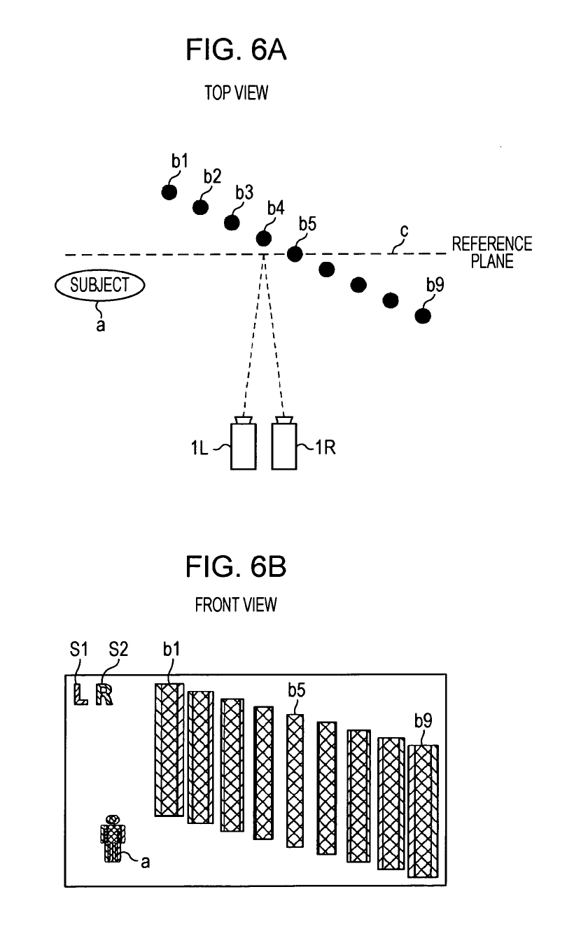

FIGS. 6A and 6B show a capture state and a display example in the left and right channel emphasis mode.

FIG. 6A is a diagram illustrating a capture state when seen from above and shows the same capture state as in FIGS. 4A and 5A.

Also, image signals for the respective channels obtained by the capturing are processed by the image processing device 2L for the left channel and the image processing device 2R for the right channel, and the left and right channel images are displayed simultaneously (or alternately) on the display device 3. FIG. 6B shows an image displayed in this way.

As shown in FIG. 6B, in the left and right channel emphasis mode, the image for the left channel captured by the camera device 1L for the left channel are plotted in a first solid color (red or the like), and the image for the right channel captured by the camera device 1R for the right channel are plotted in a second solid color (blue or the like). The respective solid color portions are marked with diagonal lines having different directions.

As can be seen from FIG. 6B, states where the ranges of the image portions for one channel overlap with the ranges of the image portions for the other channel sequentially vary, and thus the varying state can be easily ascertained.

Also, in this example, the “L” mark S1 and the “R” mark S2 which are characters indicating the left and right channels are displayed on the corner of the screen, and, of the two marks, the color of the “L” mark S1 indicating the left channel is the first color. The color of the “R” mark S2 indicating the right channel is the second color.

Due to this display, a difference between the images for the two channels can be clearly ascertained from the display on one screen. Also, the synchronization state between the images for two channels, misalignments of displayed positions and the like can be simply ascertained from the display.

Further, in each display mode, a scale (gradations) can be displayed in an image together through the process by the image processing device 2L for the left channel and the image processing device 2R for the right channel.

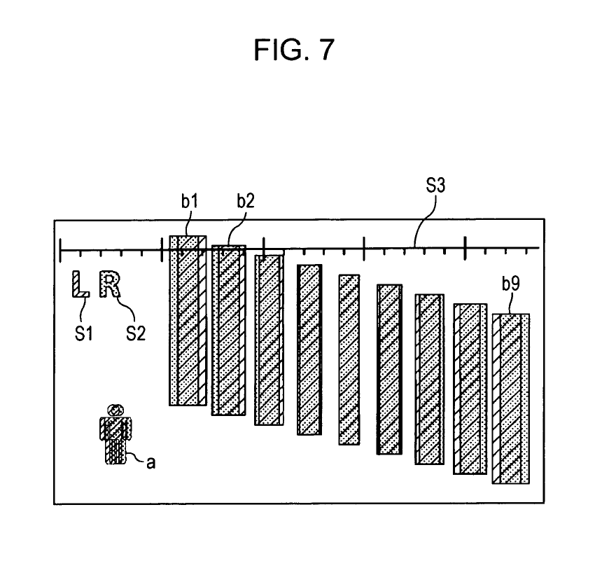

FIG. 7 shows a display example of this scale S3. As shown in FIG. 7, the scale transversely extends and has gradations at a constant interval, and, by referring to the scale, it may be found that the deviations leftwards and rightwards in the displayed image correspond to the extent of the distance from a reference surface. Further, numerical values may be attached to the gradations on the scale together.

### Configuration Examples According to Another Embodiment

In the system configuration shown in FIG. 1, the image processing device 2L for the left channel and the image processing device 2R for the right channel are separately formed but may be integrally formed.

FIG. 8 is a diagram illustrating a configuration example in this case.

In FIG. 8, an image processing device 30 is a processing device which performs the process in the image processing device 2L for the left channel and the process in the image processing device 2R for the right channel, shown in FIG. 2. That is to say, an image processing unit 2L′ for the left channel shown in FIG. 8 is a processing unit having the same processing circuit as the image processing device 2L for the left channel, and an image processing unit 2R′ for the right channel is a processing unit having the same processing circuit as the image processing device 2R for the right channel. The respective image processing units 2L′ and 2R′ process image signals from the cameras 1L and 1R for the respective channels. The image processing units 2L′ and 2R′ set process modes (display modes) in response to an instruction from the controller 4.

In the image processing device 30, image signals output from the image processing unit 2L′ for the left channel and image signals output from the image processing unit 2R′ for the right channel are supplied to a synthesis unit 5 so as to synthesize image signals of one system. The synthesized image signals are output from an output unit 6 and then supplied to a display device 7. The display device 7 may not be a display device used to perform 3D display.

Due to this configuration, even a typical display device not for use for a stereoscopic display can perform a display according to each mode shown in FIGS. 4A to 7.

FIG. 9 shows an example where the image processing device is embedded in a display device.

In a display device 40 shown in FIG. 9, image signals for the left channel input to an input terminal 41 is supplied to an image processing unit 2L′ for the left channel, and image signals for the right channel input to an input terminal 42 is supplied to an image processing unit 2R′ for the right channel. The respective image processing units 2L′ and 2R′ have the same configurations as the image processing devices 2L and 2R shown in FIG. 2 like in the example of FIG. 8 and are controlled by a controller 43 of the display device. The controller 43 instructs each display mode shown in FIG. 3 to be set.

The image signals output from the image processing unit 2L′ for the left channel and image signals output from the image processing unit 2R′ for the right channel are supplied to a synthesis unit 44 so as to synthesize image signals of one system. The synthesized image signals are supplied to a display processing unit 45. The display processing unit 45 drives a display panel 46 and displays images.

In this way, due to the configuration where all the processes are performed in the display device, a display according to each mode shown in FIGS. 4A to 7 can be performed.

Like the configuration shown in each of the drawings, a dedicated circuit of processing image signals is not configured, but, for example, a personal computer device of processing various kinds of data is installed with a board, a card or the like which corresponds to the image processing unit in this embodiment and which performs an image process (picture process). Further, in a state where the board or the like is installed in the computer device, corresponding display processes may be performed using a program (software) executed by an operation processing unit.

It should be understood by those skilled in the art that various modifications, combinations, sub-combinations and alterations may occur depending on design requirements and other factors insofar as they are within the scope of the appended claims or the equivalents thereof.

1. An image processing device comprising:
an input unit that receives at least one of image signals for a left channel and image signals for a right channel;
a color conversion processing unit that converts at least one of the image signals for the left channel and the image signals for the right channel, which are input to the input unit, into image signals for a solid color image of a specific color; and
an output unit that outputs image signals including the image signals converted in the color conversion processing unit.

2. The image processing device according to claim 1, wherein the color conversion processing unit converts the image signals for the channel different from the channel of the image signals for the solid color image of the specific color into image signals for a monochrome image.

3. The image processing device according to claim 1, wherein the image signals for at least one channel output from the output unit are to overlap an image of gradations for measuring a stereoscopic effect state.

4. The image processing device according to claim 3, wherein an image indicating the left channel overlaps with an image based on the image signals for the left channel, and an image indicating the right channel overlaps with an image based on the image signals for the right channel.

5. The image processing device according to claim 1, wherein the color conversion processing unit converts the image signals for the channel different from the channel of the image signals for the solid color image of the specific color into image signals for a solid color image of a specific color different from the specific color.

6. A display device comprising:
an input unit that receives image signals for a left channel and image signals for a right channel;
a color conversion processing unit that converts at least one of the image signals for the left channel and the image signals for the right channel, which are input to the input unit, into image signals for a solid color image of a specific color;
a synthesis unit that synthesizes the image signals for the left and right channels including the image signals converted in the color conversion processing unit; and
a display unit that displays images based on the image signals for the channels synthesized in the synthesis unit.

7. A display method comprising the steps of:
performing a color conversion process of converting at least one of image signals for a left channel and image signals for a right channel into image signals for a solid color image of a specific color; and
synthesizing the image signals for one channel having undergone the color conversion process with the image signals for the other channel so as to be displayed as one image.

8. A program product which is installed in an information processing device and which enables the information processing device to execute the steps of:
performing a color conversion process of converting at least one of image signals for a left channel and image signals for a right channel into image signals for a solid color image of a specific color; and
synthesizing the image signals for one channel having undergone the color conversion process with the image signals for the other channel so as to be displayed as one image.
